(19) United States
(12) Patent Application Publication
(10) Pub. No.: US 2012/0036527 A1
(43) Pub. Date: Feb. 9, 2012

(54) ELECTRONIC DEVICE AND METHOD FOR EMBEDDING PRODUCT INFORMATION IN TV PROGRAMS WITH PRODUCT PLACEMENTS

(75) Inventors: CHUNG-I LEE, Tu-Cheng (TW); CHIEN-FA YEH, Tu-Cheng (TW); SHAN-CHUAN JENG, Tu-Cheng (TW); CHENG-FENG TSAI, Tu-Cheng (TW); TSUNG-HSIN YEN, Tu-Cheng (TW); YU-FENG CHIEN, Tu-Cheng (TW); HO-I SUN, Tu-Cheng (TW)

(73) Assignee: HON HAI PRECISION INDUSTRY CO., LTD., Tu-Cheng (TW)

(21) Appl. No.: 13/115,069

(22) Filed: May 24, 2011

(30) Foreign Application Priority Data
Aug. 9, 2010 (TW) 99126405

(51) Int. Cl. H04N 7/025

(52) U.S. Cl. 725/32

(57) ABSTRACT

A method embeds product information in TV programs with product placements using an electronic device. The electronic device defines keywords and advertising information of products presented on a TV program, and further defines appearance times of the keywords according to product presented times. During the TV program broadcasts, the electronic device currently displays the keywords and the presented products on a display device according to the appearance times, receives a selection operation on a product presented on the display device, exports the advertising information of the selected product. The advertising information is displayed on the display device.

### BACKGROUND

1. Technical Field

Embodiments of the present disclosure generally relate to advertisement displaying devices and methods, particularly to an electronic device and method for embedding product information in TV programs with product placements.

2. Description of Related Art

Product placement is increasingly becoming a more popular form of advertising in today's media environment, especially with the growing use of digital recording devices such as TIVO and DVR that allow viewers to skip commercials. While there are numerous advantages to this marketing strategy, one major disadvantage is that the viewers have no concrete information on what the product is or even where to purchase it. This lack of information may inhibit sales growth, keeping this kind of advertising from being a better investment of advertising dollars.

### BRIEF DESCRIPTION OF THE DRAWINGS

FIG. 1 is a block diagram of one embodiment of an electronic device including an embedding unit.

FIG. 2 is a block diagram of one embodiment of function modules of the embedding unit of FIG. 1.

FIG. 3 is a flowchart illustrating one embodiment of a method for embedding product information in TV programs with product placements.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

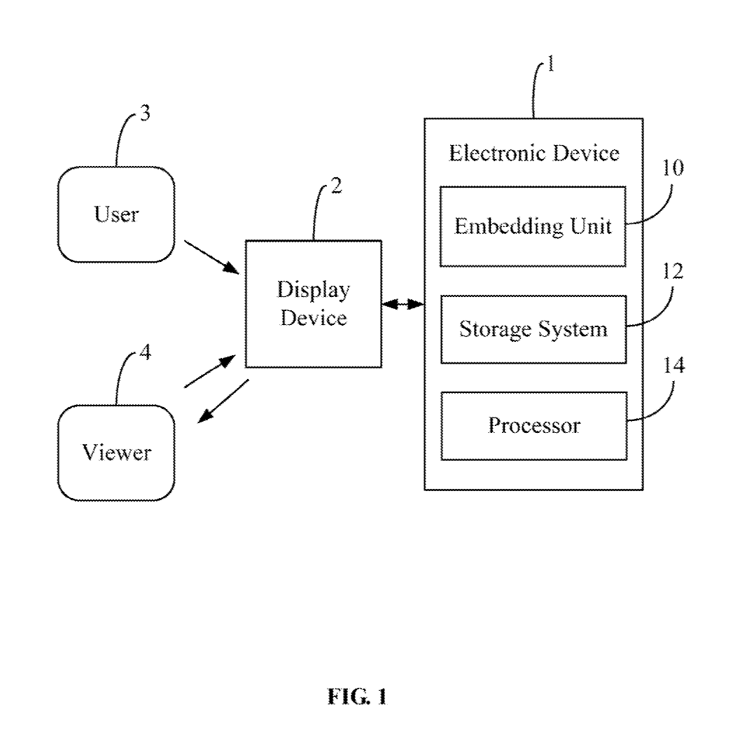

FIG. 1 is a block diagram of one embodiment of an electronic device 1 including an embedding unit 10. In the embodiment, functions of the embedding unit 10 are implemented by the electronic device 1; the embedding unit 10 can embed advertising information of products presented in a TV program, and display the advertising information on a display device 2 that is electronically connected to the electronic device 1 via a wired or wireless connection during the TV program broadcasts. In one embodiment, the products may be cars, watches, or clothes. The advertising information of the products may be presented using, for example, text, audio, advertisement files, Web advertisements, and/or shopping websites. The TV program may be a movie, a TV series, or any other entertainment show.

In one embodiment, the electronic device 1 may be a computer, a TV, a portable electronic device, or any other electronic device that includes a storage system 12 and at least one processor 14.

The embedding unit 10 is configured to receive keywords and advertising information of presented products, and define keyword appearance time along with the product presentation time of a TV program from a user 3. When a viewer 4 taps any keyword displayed on the TV program (e.g., using a finger or a stylus) displayed on the display device 2 to select a presented product, the embedding unit 10 can export the advertising information of the selected product, and display the advertising information of the selected information on the display device 2. Details of these operations are shown below.

The display device 2 receives a selection operation of the product from the viewer 4, and displays the advertising information of the selected product. In the embodiment, the display device 2 is a touch-sensitive display or a 3D display, and can receive an input operation of the viewer 4 using a finger or a stylus pen. For example, if the electronic device 1 is a TV, the viewer 4 can use a remote control to operate (i.e., select a product) the electronic device 1.

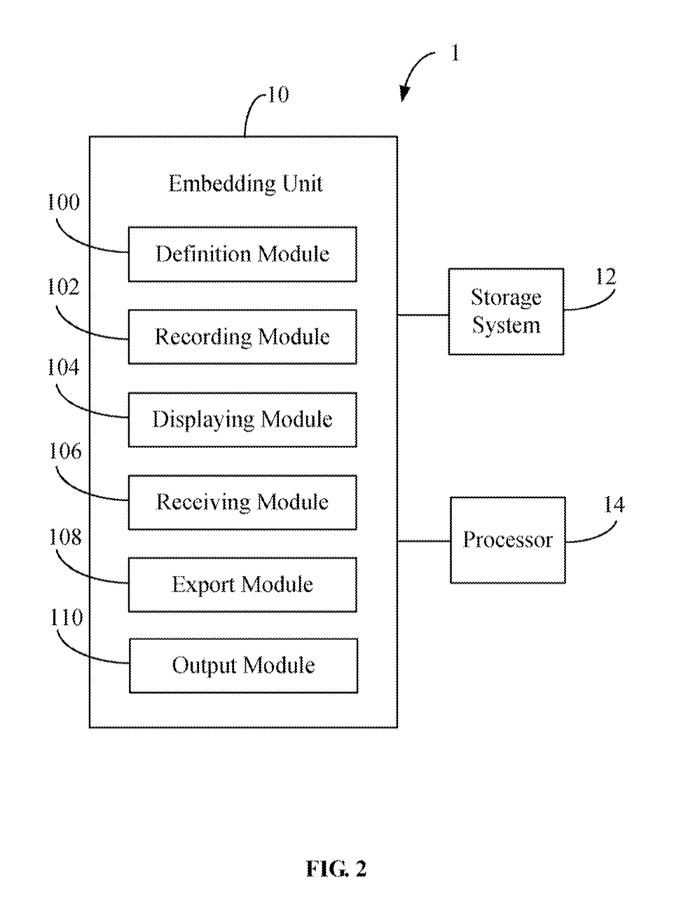

FIG. 2 is a block diagram of one embodiment of function modules of the embedding unit 10 of FIG. 1. In one embodiment, the embedding unit 10 includes a definition module 100, a recording module 102, a displaying module 104, a receiving module 106, an export module 108, and an output module 110. Each of the modules 100-110 may be a software program including one or more computerized instructions that are stored in the storage system 12 and executed by the processor 14.

In one embodiment, the storage system 12 may be a magnetic or an optical storage system, such as a hard disk drive, an optical drive, or a tape drive.

Before the display device 2 broadcasts a TV program, the definition module 100 defines keywords and advertising information of the presented products on the TV program. Furthermore, the definition module 100 defines the appearance times of the keywords according to the product presentation times, so the each keyword is displayed concurrently with the corresponding product during the TV program broadcasting. In the embodiment, the TV program may be a movie, a TV series, or any other entertainment shown. Each of the appearance times includes a start time and an end time of the keywords to be presented on the TV program.

The recording module 102 records the keywords, the advertising information, and the appearance times of the keywords in an image file or a movie file that is compatible with the TV program. In one embodiment, the movie file may be in format of a MPEG-2, MPEG-4, or an AVC format.

The displaying module 104 currently displays the keywords and the presented products on the display device 2 according to the appearance times. In the embodiment, the keywords can be displayed in the periphery of a display screen of the display device 2, such as an upper left corner, an upper right corner, a lower left corner, or a lower right corner of the display device 2.

When the display device 2 displays the TV program, the receiving module 106 receives a selection operation of a product from the viewer 4. For one example, if the display device 2 is a touch-sensitive display, the viewer 4 may use a finger or a stylus to tap the keyword of the presented product to select the product, and then the receiving module 106 receives the selection operation. For another example, the selection of the keywords is a taping of a mouse, or a depression of a button of a remote control.

The export module 108 exports the advertising information of the selected product from the image file or the movie file.

The output module 110 displays the advertising information of the selected product on the display device 2, so that the viewer 4 can browse the advertising information of the selected product.

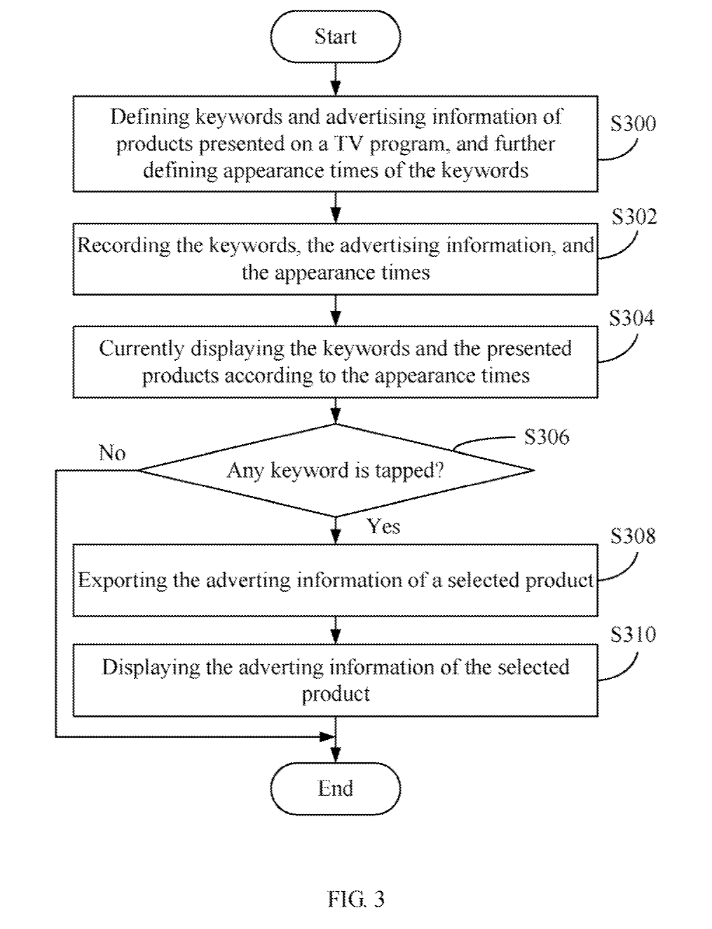

FIG. 3 is a flowchart illustrating one embodiment of a method for embedding product information in TV programs with product placements. Depending on the embodiment, additional blocks may be added, others removed, and the ordering of the blocks may be changed.

In block S300, the definition module 100 defines keywords and advertising information of presented products of a TV program. Furthermore, the definition module 100 defines the keyword appearance time according to the product presentation time. In the embodiment, the advertising information may be delivered using texts, audio, advertisement files, web advertisement, and/or shopping websites. Each keyword appearance time includes a start time and an end time of the keywords to be presented on the TV program.

In block S302, the recording module 102 records the keywords, the advertising information, and the appearance times of the keywords in an image file or a movie file that is compatible with the TV program. In the embodiment, the movie file may be in format of a MPEG-2, MPEG-4, or an AVC format.

When the display device 2 displays the TV program, in block S304, the displaying module 104 currently displays the keywords and the presented products on the display device 2 according to the appearance times. In the embodiment, the keywords can be displayed in the periphery of a display screen of the display device 2, such as an upper left corner, an upper right corner, a lower left corner, or a lower right corner of the display device 2.

In bock S306, the receiving module 106 determines whether any keyword presented on the TV program has been tapped by the viewer 4. In one example, the viewer 4 may touch the display device 2 with a finger or a stylus to select the keyword of a presented product, to select the presented product. If any keyword has been tapped, block S308 is implemented. If no keyword is tapped, the flow ends.

In block S308, the export module 108 exports the advertising information of the selected product from the image file or the movie file.

In block S310, the output module 110 displays the advertising information of the selected product on the display device 2, so that the viewer 4 can browse the advertising information of the selected product.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for embedding product information in TV programs with product placements using an electronic device, the method comprising:
defining keywords and advertising information of products presented on a TV program, and defining appearance times of the keywords according to product presentation times of the presented products;
displaying the keywords of the presented products on a display device concurrently with the presented products according to the appearance times, the display device electronically connected to the electronic device during the TV program;
receiving a selection operation for a product selected from the presented products displayed on a display device, the selection operation according to selection of a keyword of the product;
exporting the advertising information of the selected product; and
displaying the advertising information of the selected product on the display device.

2. The method as described in claim 1, further comprising:
recording the keywords, the appearance times and the advertising information of the presented products in an image file or a movie file that is compatible with the TV program.

3. The method as described in claim 2, wherein the movie file is in a MPEG-2, MPEG-4, or an AVC format.

4. The method as described in claim 1, wherein the TV program is a movie, a TV series, or an entertainment show.

5. The method as described in claim 1, wherein each of the appearance times includes a start time and an end time of the keyword to be presented on the TV program.

6. The method as described in claim 1, wherein the advertising information is delivered using text, audio, advertisement files, web advertisements, and/or shopping websites.

7. An electronic device, comprising:
at least one processor;
a storage system; and
one or more modules that are stored in the storage system and are executed by the at least one processor, the one or more modules comprising instructions:
to define keywords and advertising information of products presented on a TV program, and to define appearance times of the keywords according to product presentation times of the presented products;
to display the keywords of the presented products on a display device concurrently with the presented products according to the appearance times, the display device electronically connected to the electronic device during the TV program;
to receive a selection operation for a product selected from the presented products displayed on a display device, the selection operation according to selection of a keyword of the product;
to export the advertising information of the selected product; and
to display the advertising information of the selected product on the display device.

8. The electronic device as described in claim 7, wherein the instructions further record the keywords, the appearance times and the advertising information of the presented products in an image file or a movie file that is compatible with the TV program.

9. The electronic device as described in claim 8, wherein the movie file is in a MPEG-2, MPEG-4, or an AVC format.

10. The electronic device as described in claim 7, wherein the TV program is a movie, a TV series, or an entertainment show.

11. The electronic device as described in claim 7, wherein each of the appearance times includes a start time and an end time of the keyword to be presented on the TV program.

12. The electronic device as described in claim 7, wherein the advertising information is delivered using text, audio, advertisement files, web advertisements, and/or shopping websites.

13. A non-transitory storage medium having stored thereon instructions that, when executed by a processor of an electronic device, causes the processor to perform a method for embedding product information in TV programs with product placements, the method comprising:
defining keywords and advertising information of products presented on a TV program, and defining appearance times of the keywords according to product presentation times of the presented products;
defining keywords and advertising information of presented products of a TV program, and defining appearance times according to product presentation times of the presented products;
currently displaying the keywords and the presented products on a display device according to the appearance times;
receiving a selection of a product from the presented products displayed on a display device that is electronically connected to the electronic device during the TV program broadcasts;
exporting the advertising information of the selected product; and
displaying the advertising information of the selected product on the display device.

14. The non-transitory storage medium as described in claim 13, wherein the method further comprises:
recording the keywords, the appearance times and the advertising information of the presented products in an image file or a movie file that is compatible with the TV program.

15. The non-transitory storage medium as described in claim 14, wherein the movie file is in a MPEG-2, MPEG-4, or an AVC format.

16. The non-transitory storage medium as described in claim 13, wherein the TV program is a movie, a TV series, or an entertainment show.

17. The non-transitory storage medium as described in claim 13, wherein each of the appearance times includes a start time and an end time of the keyword to be presented on the TV program.

18. The non-transitory storage medium as described in claim 13, wherein the advertising information is delivered using text, audio, advertisement files, web advertisements, and/or shopping websites.
